(19) United States
(12) Patent Application Publication
(10) Pub. No.: US 2006/0278657 A1
(43) Pub. Date: Dec. 14, 2006

(54) Concentrate dispensing units and disposable concentrate packages including impeller pumps

(76) Inventor: Calin V. Roatis, Long Grove, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 11/453,178

(22) Filed: Jun. 14, 2006

Related U.S. Application Data
(60) Provisional application No. 60/690,648, filed on Jun. 14, 2005.

(51) Int. Cl. B67D 5/56

(52) U.S. Cl. 222/129.1

(57) ABSTRACT

The invention provides a concentrate dispensing unit. The concentrate dispensing unit comprises a disposable concentrate package. The disposable concentrate package may be mounted on one or more brackets and may include a container for storing a concentrate fluid and a pump. The pump is a disposable impeller pump that may be coupled to the container and may be utilized to draw concentrate fluid from the container. The concentrate fluid may then be intermixed with another fluid, such as water, to form a homogeneous beverage.

### CROSS-REFERENCE TO RELATED APPLICATIONS

This patent application claims the benefit of U.S. Provisional Patent Application No. 60/690,648, filed Jun. 14, 2005.

### FIELD OF THE INVENTION

The invention pertains to concentrate dispensing units, and more specifically, concentrate dispensing units including disposable concentrate packages having impeller pumps for drawing concentrate fluid from containers.

### BACKGROUND OF THE INVENTION

Liquid dispensing systems for concentrated liquid, such as juice concentrate, have typically consisted of two types of technology.

Air or liquid pressurized systems have been used by some companies as a reliable method for dispensing and mixing concentrate. However, these systems require additional devices for controlling the pressure. A pressurized system, without the use of a pump, requires an increase in the strength and size of the container. Using a pressurized system with a high viscosity concentrate further increases the demands on the container strength. When a pressurized system is being used in conjunction with a progressive pump (See U.S. Pat. Nos. 5,615,801 and 6,651,849) additional elements are provided as part of the package to be disposed, thus increasing the cost of the unit.

Disposable diaphragm pumps were introduced to eliminate the maintenance issue found in the pressurized systems, but these pumps also required check valves and have additional drawbacks such as pulsating flow, uneven mixture, and noise. These disposable pump systems have questionable interconnect components and methods that also need to be improved. These pumps are not suited for fluids that might have solid components that may obstruct the valves in open or closed position. Other drawbacks to these systems are performance and quality of the dispensing of the liquids. See U.S. Pat. No. 6,394,773.

Gear pumps have been tried in lieu of the disposable pump technology in U.S. Pat. No. 6,394,773, but gear pumps also have drawbacks in terms of flow rates, uneven flows, and requiring check valves. Similar to diaphragm pumps, these pumps do not perform well when solid immersions are present in the fluid because gears can jam or be difficult to start.

Therefore, there is a need for an improved dispensing system.

### BRIEF SUMMARY OF THE INVENTION

The invention provides a concentrate dispensing unit. The concentrate dispensing unit comprises a disposable concentrate package. The disposable concentrate package may be mounted on one or more brackets and may include a container for storing a concentrate fluid and a pump. The pump is a disposable impeller pump that may be coupled to the container and may be utilized to draw concentrate fluid from the container. The concentrate fluid may then be intermixed with another fluid, such as water, to form a homogeneous beverage. Listed below are some of the objects of the invention:

An object of the invention is to provide a pump for a consumable fluid that is disposable and does not require to be re-used and maintained (cleaning and/or flushing).

Another object of the invention is to provide a pump that is readily connected or attached to the container of the liquid.

Another object of the invention is to provide a simple adapter from the container of the liquid to the pump.

Another object of the invention is to provide a pump that has improved performance compared to diaphragm and/or gear pumps.

Another object of the invention is to provide a pump that does not require use of check valves at the inlet or outlet of the pump.

Another object of the invention is to provide a pump that does not cause pulsing of fluid and provides an even flow of fluid.

Another object of the invention is to provide a pump that provides an adequate flow of fluid concentrate in relation to the water pressure and flow.

Another object of the invention is to provide a pump that reduces/eliminates pressurization or vacuum pressure in the system.

Another object of the invention is to provide a mixer that is easily and simply connected/attached to the pump.

Another object of the invention is to provide a motor to operate the pump that is easily and simply connected/attached to the pump.

Another object of the invention is to provide a motor that operates with reasonable torque and speed levels to reduce the power and control components needed to operate, start and stop the pump.

Another object of the invention is to provide a pump that is not susceptible to stalling and/or jamming.

Another object of the invention is to provide a motor that is not required to operate in a reverse direction.

Another object of the invention is to provide a motor and control that have reduced operation, control steps, and hardware.

Another object of the invention is to provide low-cost materials to construct the pump and the interconnects.

Another object of the invention is to provide a reduced connection process to connect the components to reduce the errors associated with installation and maintenance.

Another object of the invention is to provide improved alignment of the components to reduce the errors associated with installation and maintenance.

Another object of the invention is to provide a pump that will operate with reduced/reasonable number of revolutions per minute to reduce pressure build-up and reduce seal leakage.

Another object of the invention is to provide a simple air intake breather system.

Another object of the invention is to provide a system capable of pumping fluids in a large variety of viscosities and with accidental or purposeful solid suspension such as orange pulp, peel, etc.

### BRIEF DESCRIPTION OF THE SEVERAL VIEWS OF THE DRAWING(S)

FIG. 1 is a perspective view of the concentrate dispensing unit of the present invention.

FIG. 2 is a perspective view of the disposable package.

FIG. 3 is an exploded view of the disposable package.

FIG. 4 is an exploded view of the pump.

FIG. 5 is a perspective view of the pump.

FIG. 6 is a perspective view of the motor bracket.

FIG. 6B is another perspective view of the motor bracket taken from the side of the electrical motor.

FIG. 7 is a perspective view of the pump retention and release mechanism.

FIG. 8 is another perspective view of the pump retention and release mechanism taken from the mounting side.

FIG. 9 is an elevational side view of the container.

FIG. 10 is a perspective view of the posterior bracket.

FIG. 11 is an exploded view of the disposable package before being assembled into the dispensing unit.

FIG. 11B is an elevational side view of the disposable package before being assembled into the dispensing unit.

FIG. 12 is an enlarged fragmentary view of the disposable package and motor bracket prior to assembly.

FIG. 12B is an enlarged fragmentary view of the disposable package and motor bracket after assembly.

### DETAILED DESCRIPTION OF THE INVENTION

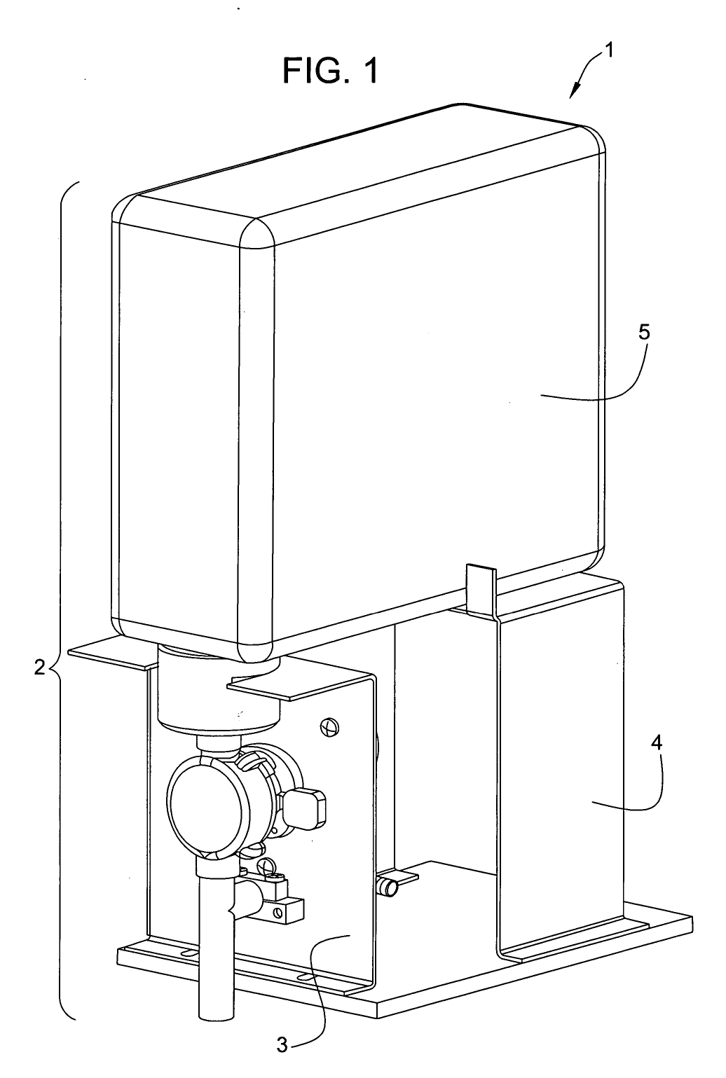

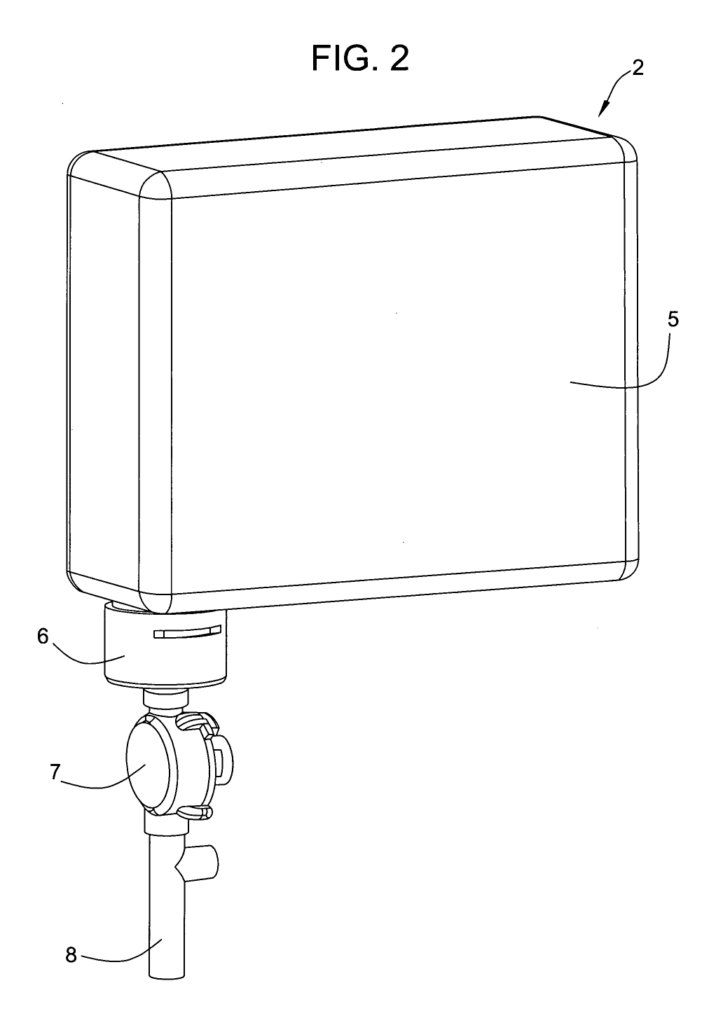

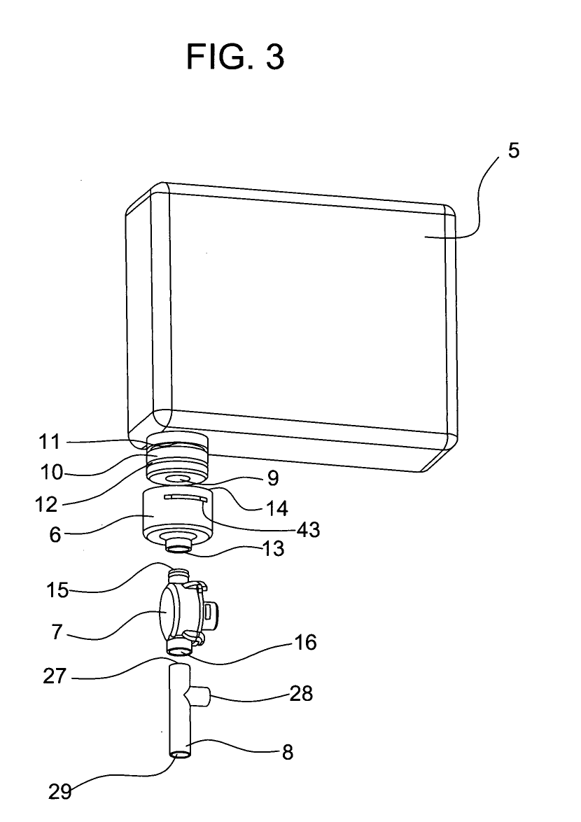

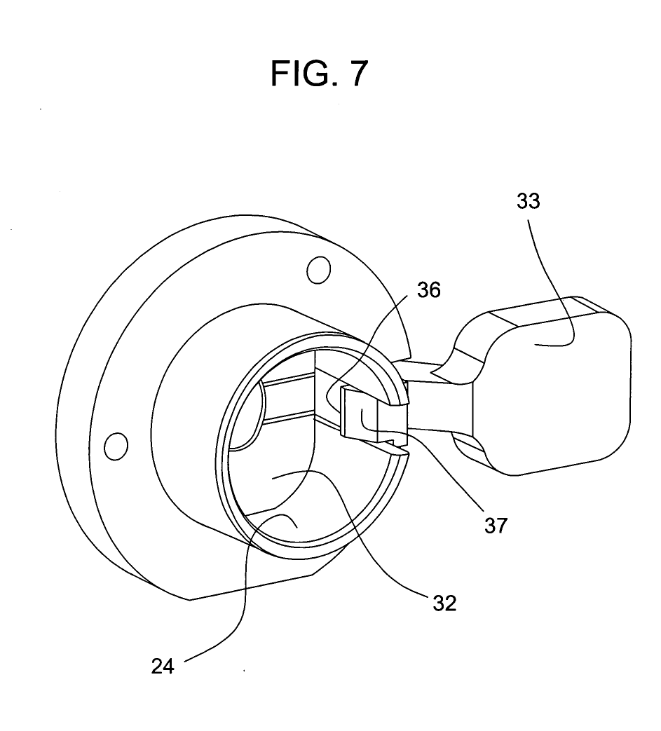

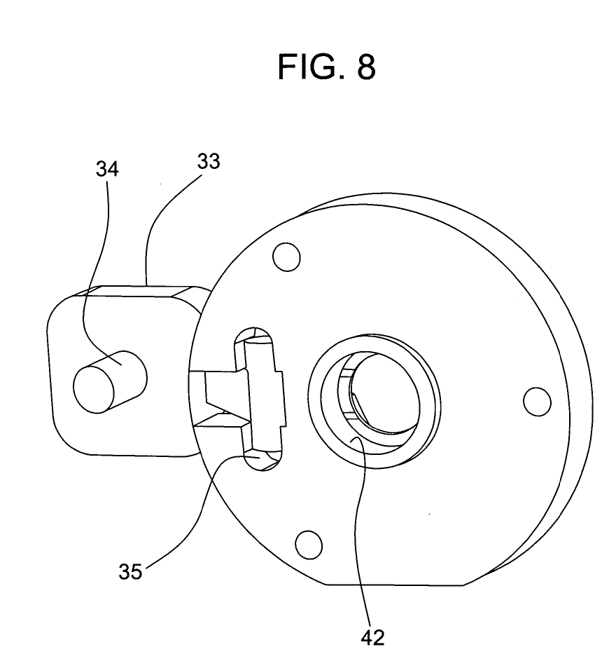

Referring now to the drawings, in which like numerals indicate like elements through several views, FIGS. 1-12B, a concentrate dispensing unit 1 is shown in FIG. 1. The concentrate dispensing unit 1 may comprise a disposable concentrate package 2, a motor assembly bracket 3, and a posterior support bracket 4. The concentrate dispensing unit 1 as a whole may be secured within a dispenser cabinet (not shown). As shown in FIGS. 2 and 3, the disposable concentrate package 2 may include a container 5, a pump adapter 6, a pump 7 and a spigot 8.

It will be appreciated that the container 5 may be of any suitable conventional design and may be constructed of any suitable material, including but not limited to, conventional thermoplastics or similar materials. Further, the container 5 may be rigid or flexible. As shown in FIG. 3, the container may include an aperture 9 defined by a neck portion 10. The container 5 may also include a retaining groove 11 and a seal ring 12.

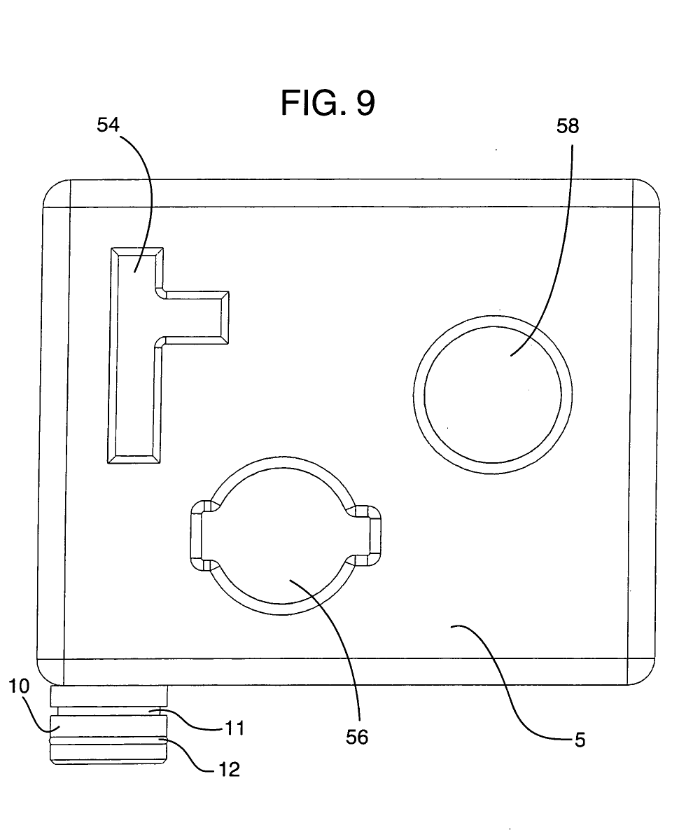

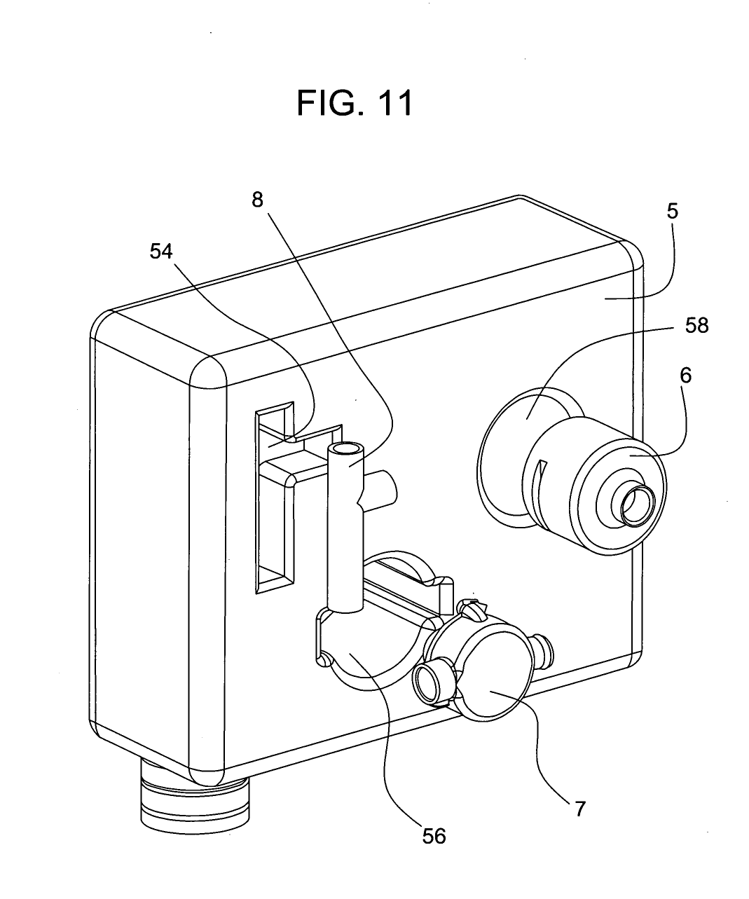

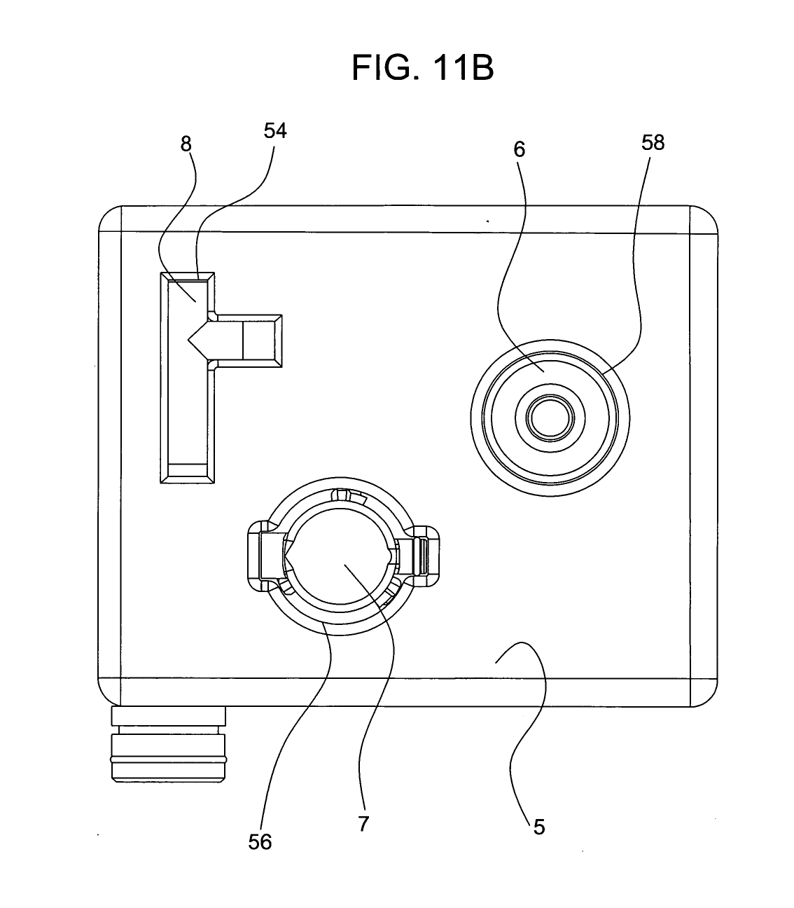

Turning to FIGS. 9, 11, and 11B, for the purpose of easy transportation and convenient storage, the container 5 may also contain recessed areas (such as 54, 56, and 58) that will retain pump adapter 6, pump 7, and mixer 8. The container 5 may be disposable or reusable.

Referring again to FIG. 3, the adapter 6 may be a substantially tubular structure with a container port 14 and a pump port 13. The adapter container port 14 may be sized to accommodate the neck portion 10 of the concentrate container 5. The adapter port 13 may be sized to accommodate the pump input port 15. The adapter may also contain two lateral locking notches 43.

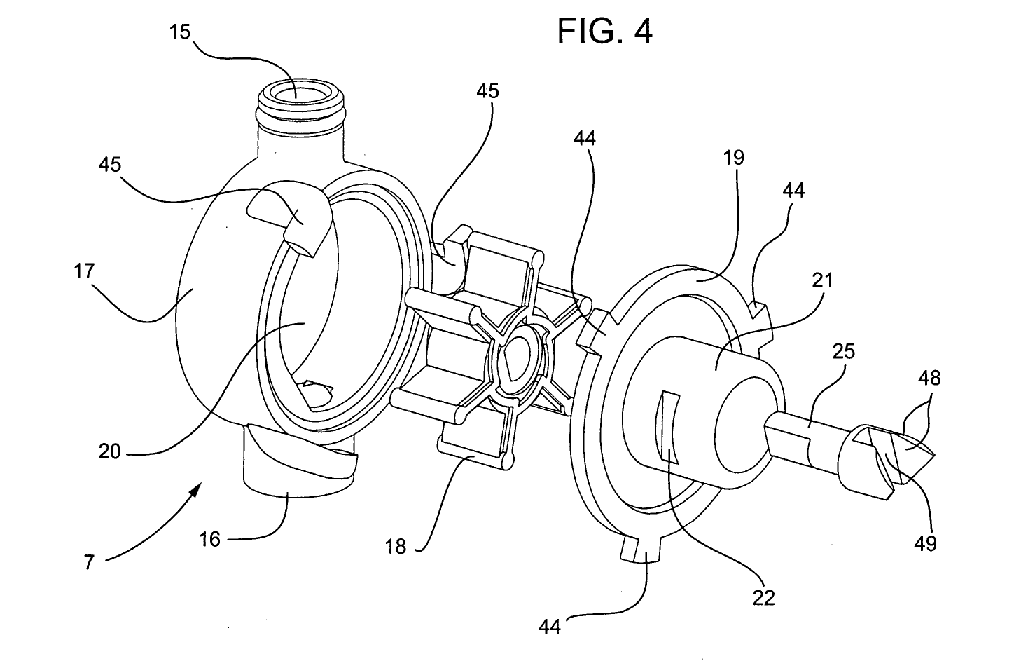

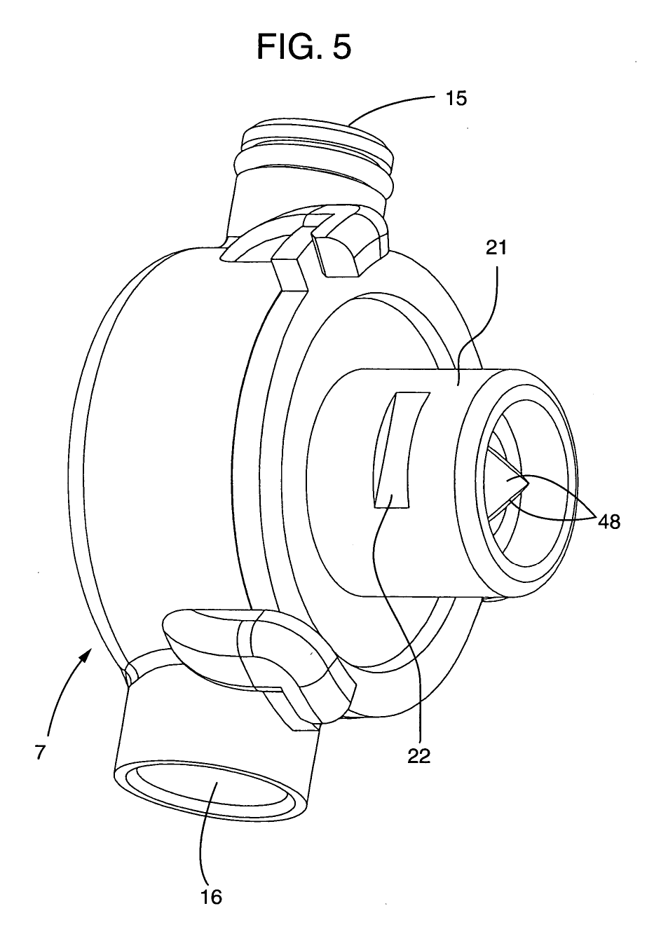

Turning to FIGS. 4 and 5, the pump 7 may include a pump input port 15 and an output port 16. The pump components may include a pump body 17, an impeller 18, a cover 19, and a pump shaft 25.

The impeller 18 is housed in the pump chamber 20. The impeller 18 is secured in chamber 20 by the pump cover 19. Pump cover tabs 44 are engaged with pump body 17 retaining elements 45. The rotation direction of the impeller 18 coincides with the direction that will maintain the cover 19 securely locked. It will be appreciated that the pump cover 19 may be coupled to the pump body 17 in any suitable manner.

Referring to FIGS. 4-6, the pump cover 19 may be configured to include a tubular surface 21 that will concentrically engage surface 24 of the motor flange 23 in order to ensure a concentric engagement of the motor shaft 26 with the pump shaft 25.

The pump cover 19 may also include a notch 22 that will engage the lever tooth 33 when the pump is inserted into the motor flange 23.

During pump insertion into the motor flange 23, aligning surfaces 48 and 49 of the pump shaft 25 will engage surface 46 of the motor shaft 26 thus aligning motor shaft 26 and pump shaft 25 such that the driving surface 49 of the pump shaft 25 fully engages with the driving surface 47 of the motor shaft 26. The impeller 18 may be constructed of silicone rubber to allow the blades of the impeller 18 to follow the side walls of the pump chamber 20 and carry between the connective blades the concentrate and the solid suspension. It will be appreciated that the impeller may be constructed of any suitable material.

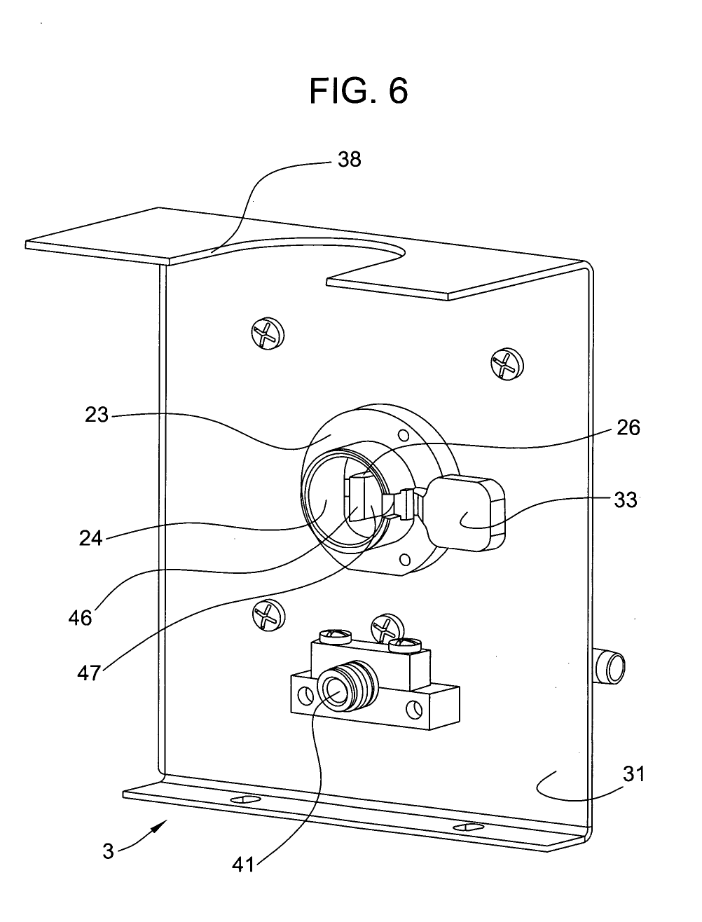

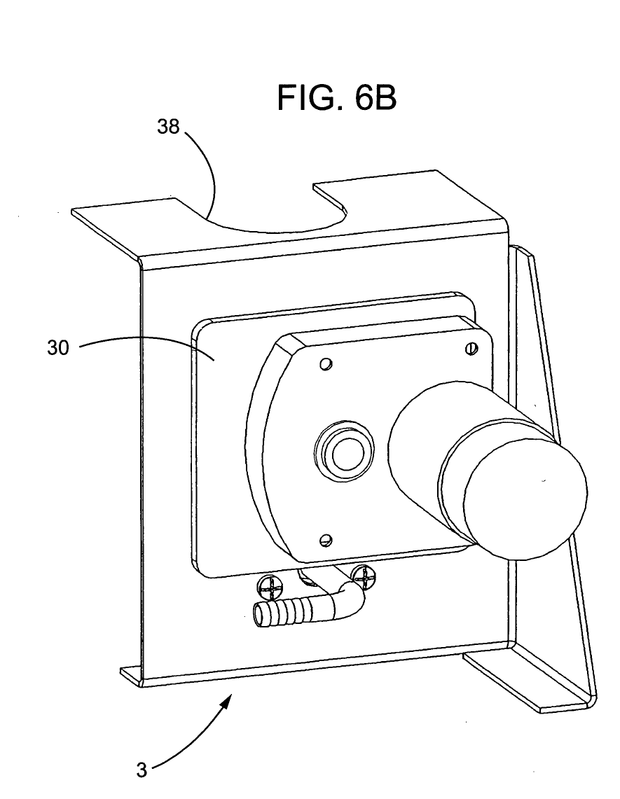

Turning again to FIG. 3, the mixing element or spigot 8 may include pump port 27, a water port 28, and delivery port 29. Pump port 27 may be sized to accommodate pump output port 16. Water port 28 may be sized to accommodate the water intake 41, shown in FIG. 6.

The container 5, the adapter 6, the pump 7, and the spigot 8 may join to form a single component as in FIG. 2.

The adapter 6, the pump body 17 and the spigot 8 may be made in an injection molding process or other suitable manufacturing process as separate parts or as a single body thus eliminating the need for separate assembly at the time of replacing the disposable concentrate package.

As shown in FIGS. 6-8, the motor assembly bracket 3 may contain an electric motor 30 fastened to the bracket 31 and a motor flange 23 fastened to the bracket, while the motor shaft 26 outside diameter will retain concentricity with the surface 42 of the motor flange 23. Motor flange 23 will also retain within recess 35 the lever 33 while the flange 23 is fastened to the bracket 31.

The lever 33 may contain a spring element 34 to ensure a positive lock of surface 36 with the notch 22 of the pump cover 19, and an angled surface 37 to move the lever 33 radially out when pump 7 is inserted. The motor assembly bracket may also contain an elastic element 32, nested at the bottom of surface 24, that will push pump 7 and facilitate the eject when lever 33 is pressed.

The motor assembly bracket 3 may also contain a locking surface 38 that will engage a neck groove in the container, thus creating a secure location for container retaining groove 11 in relation to motor shaft 26 and water intake 41.

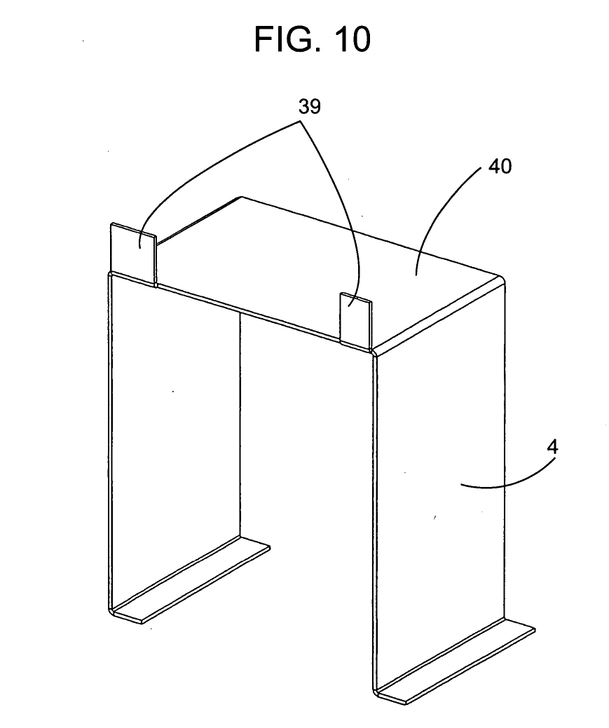

As shown in FIG. 10, the posterior bracket 4 may contain two tabs 39 with the purpose of laterally locating container 5 at the time of inserting the disposable package 2. The posterior bracket 4 also contains horizontal surface 40 for container 5 support. The posterior bracket 4 may be made of injection molding process, stamped and formed material, can be a single body with the motor bracket 31 or, along with described features, may be part of the dispenser cabinet (not shown). It will be appreciated that the posterior bracket 4 may be formed in any suitable manner.

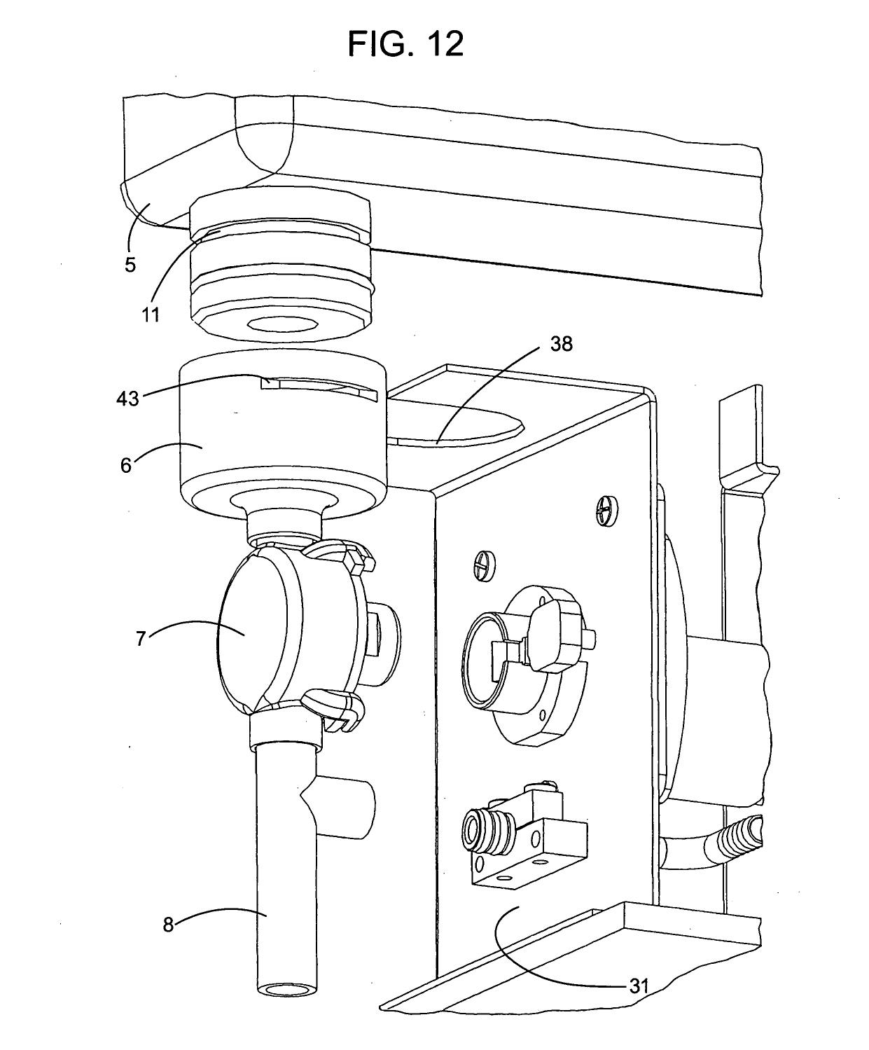

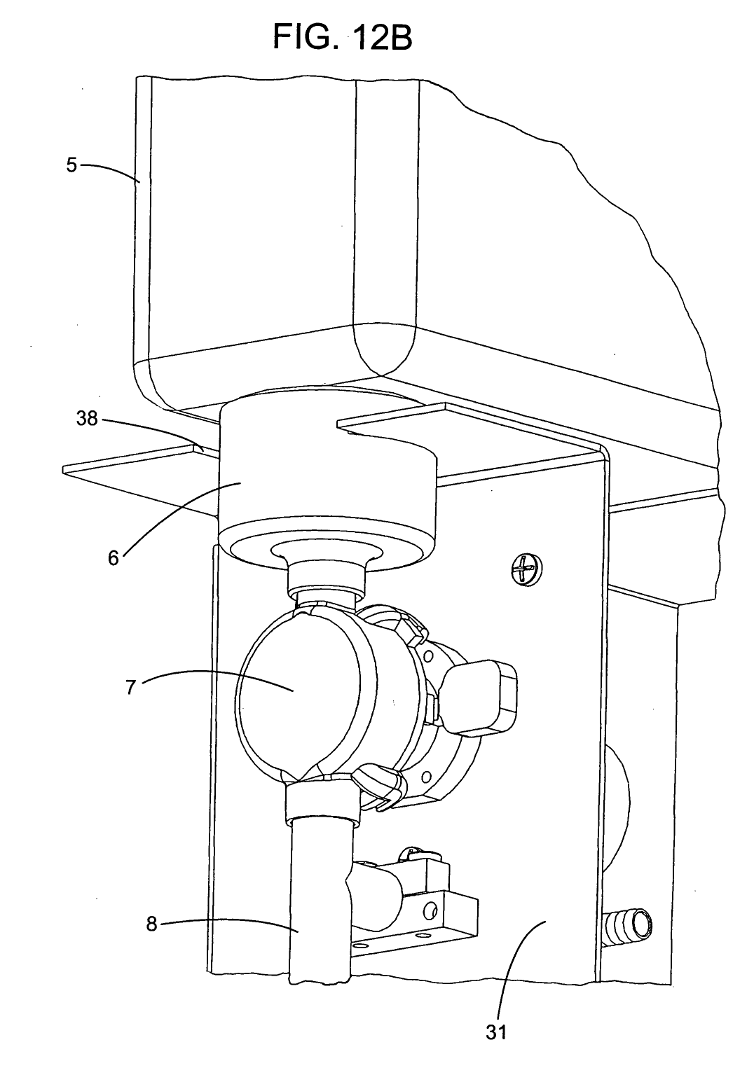

In another embodiment of this invention (FIGS. 12-12B) adapter 6 may have two lateral slots 43 that, at the time of coupling to container 5, will match the top surface of the container retaining groove 11.

At the time of inserting the disposable package 2 into the dispensing unit 1, adapter 6 and container 5 may be locked together by the edge 38 of the motor bracket 31.

Replacing the empty disposable package may include the following steps. Used disposable package 2 is removed by pressing lever 33 and sliding backwards disposable package 2 until it is completely disconnected from motor flange 23 and the water intake 41.

From a new disposable package, the pump adapter 6, the pump 7, and the spigot 8 are connected together such as shown in FIG. 2.

The new assembly just created will be inserted into the concentrate dispensing unit 1 with surface 43 of the adapter 6 engaging surface 38 of the motor bracket 31 until the lever 33 latches the pump 7 securely in place. Upon insertion of the disposable package 2 into the dispensing unit, the container 5 may be punctured in the topside by a breather punch (not shown) thus creating an air intake. When the pump is activated, air will enter the container 5 via a breather punch in order to avoid creating a vacuum in the container 5.

In an alternate embodiment of this invention, adapter 6, pump 7 and the spigot 8 may be a single component that can be directly assembled to container 5.

Upon completion of the assembly, the concentrate unit is ready to dispense the mixed drink. On user selection activation (not shown), the water valve will open (may be electrically activated). Simultaneously, voltage will be applied to the electrical motor 30.

This action will initiate the rotation of the impeller 18 and the concentrate will start passing from the container 5 into spigot 8. The voltage applied to the motor may be of a constant value, or may vary by a function related to the water pressure and/or flow, in order to maintain a proper mixture ratio of concentrate to water. The flow of concentrate from pump 7 and the flow of water from water intake 41 will blend inside the body of the spigot 8 to deliver a homogenous drink at the delivery port 29.

The present invention includes a disposable concentrate package that will provide a smooth flow of the concentrate without the use of additional valves required to stop the flow of the concentrate while the pump is not activated.

The disposable package does not require qualified personel to assemble, disassemble, and operate. Because the packaging is disposable, no cleaning or water flushing of the concentrate dispensing unit is required when using perishable food concentrates.

Although the compatibility of the materials within the disposable package with the products to be dispensed should be considered, the pump 7 may be used with a wide variety of concentrates and liquids of various temperatures, viscosities, and other properties.

Although the concentrate is described as intermixing with water, it will be appreciated that the concentrate may be intermixed with any suitable liquid.

Further, because all or most of the components may be manufactured out of thermoplastics, the disposable package 2 can be relatively inexpensively mass-produced.

Any references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor(s) for carrying out the invention. Variations of those preferred embodiments may become apparent to those of ordinary skill in the art upon reading the foregoing description. The inventor(s) expect skilled artisans to employ such variations as appropriate, and the inventor(s) intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A disposable concentrate package, the package comprising:
a container for storing a concentrate fluid; and
a pump coupled to the container and including an impeller for drawing the concentrate fluid from the container.

2. The disposable concentrate package of claim 1 wherein the container further comprises a recess for storing the pump.

3. The disposable concentrate package of claim 1 further comprising a spigot.

4. The disposable concentrate package of claim 3 wherein the spigot further comprises a port for introducing a second fluid to the concentrate fluid.

5. The disposable concentrate package of claim 1 further comprising an adapter for coupling the pump to the container.

6. The disposable concentrate package of claim 1 wherein the impeller is constructed of silicone rubber.

7. The disposable concentrate package of claim 1 wherein the container and the pump are constructed of a thermoplastic.

8. The disposable concentrate package of claim 1 wherein the pump further comprises a shaft having a drive surface.

9. The disposable concentrate package of claim 1 wherein the impeller comprises a plurality of blades, and wherein at least one of the plurality of blades has a rounded end.

10. A concentrate dispensing unit, the dispensing unit comprising:
a bracket; and
a disposable concentrate package removably mountable to the bracket, the disposable concentrate package including an impeller pump.

11. The concentrate dispensing unit of claim 10 further comprising a lever for releasably attaching the impeller pump to the bracket.

12. The concentrate dispensing unit of claim 11 wherein the pump comprises a notch for receiving the lever.

13. The concentrate dispensing unit of claim 10 wherein the disposable concentrate package has a groove for mounting the disposable concentrate package to the bracket.

14. The concentrate dispensing unit of claim 10 wherein the pump further comprises a shaft coupled to the impeller such that the shaft is connectable to a motor to drive the impeller.

15. The concentrate dispensing unit of claim 14 wherein a relatively constant voltage is applied to the motor.

16. The concentrate dispensing unit of claim 14 wherein the voltage applied to the motor is a function related to at least one of a water pressure and a water flow rate.

17. The concentrate dispensing unit of claim 14 wherein the motor is coupled to the bracket.

18. The concentrate dispensing unit of claim 10 further comprising a fluid intake for receiving a second fluid.

19. The concentrate dispensing unit of claim 10 wherein the disposable concentrate package further comprises a container for containing concentrate fluid.

20. The concentrate dispensing unit of claim 10 wherein the disposable concentrate package is a single unitary structure.

21. The concentrate dispensing unit of claim 10 wherein the disposable concentrate package includes a plurality of components that can be assembled.

22. A method for providing a dispenser for concentrate fluid, the method comprising:
providing a disposable concentrate package, the package comprising a container including a concentrate and a pump having an impeller; and
coupling the disposable concentrate package to a dispenser apparatus.

23. The method of claim 22 further comprising loading the disposable concentrate package onto a bracket.

24. The method of claim 22 further comprising coupling the pump to a motor.

25. The method of claim 24 further comprising activating the motor to rotate the impeller and draw the concentrate from the container.

26. The method of claim 22 further comprising coupling a spigot to the pump.

27. The method of claim 26 further comprising attaching the spigot to a port for dispensing a second fluid.

28. The method of claim 22 further comprising removing the pump from a recess in the container.

29. The method of claim 22 further comprising coupling the container to the pump.

30. The method of claim 22 further comprising coupling an adapter to the pump and the container.

31. The method of claim 22 further comprising removing a substantially empty disposable concentrate package.

32. The method of claim 31 further comprising disposing of the substantially empty disposable concentrate package.

33. The method of claim 22 further comprising puncturing the container.
